(19) United States
(12) Patent Application Publication
(10) Pub. No.: US 2014/0043389 A1
(43) Pub. Date: Feb. 13, 2014

(54) PRINTER OPERATION

(71) Applicant: Robin Angus, Fife (GB)

(72) Inventor: Robin Angus, Fife (GB)

(73) Assignee: NCR CORPORATION, Duluth, GA (US)

(21) Appl. No.: 13/568,919

(22) Filed: Aug. 7, 2012

(51) Int. Cl. B41J 29/393

(52) U.S. Cl. 347/19

(57) ABSTRACT

A method and apparatus are provided for determining a state of operation of a printer element. The method includes the steps of determining at least one optical value for an item of media as it is transported to a printer element, determining at least one optical value for the item of media as it is transported from the printer element, comparing the input and output optical values and responsive to the comparison determining a state of operation of the printer element.

### FIELD OF THE INVENTION

The present invention relates to a method and apparatus for determining a state of operation of a printer. In particular, but not exclusively, the present invention relates to a method of determining if a printer is operating correctly in a Self-Service Terminal (SST).

### BACKGROUND TO THE INVENTION

Various Self-Service Terminals (SSTs) are known in which items of media are deposited in the terminal and/or dispensed from the terminal. For example, some Automated Teller Machines (ATMs) utilize modules which enable currency notes to be removed when desired from an internal storage region and optionally, when deposited by a user at a terminal, currency notes may be placed into a storage region for subsequent use. Some conventional ATMs also enable users to deposit items of media such as currency notes or checks. The currency notes or checks can be deposited on their own or by a customer pre-loading the items that are to be deposited in an envelope. Envelope and check deposit devices must print on customer deposited media for archiving and auditing purposes. However, when a printer element used to mark the item of media (including the envelope in which further items may be stored) in some way fails due to a fault, ink running out or other reasons, there may not be any indication of a printing failure. Typically, nobody complains about the print failure until the data that should have been printed is required, such as for reconciliation, or for an audit process.

Future check readers are likely to image checks and return them to a customer rather than store them in a terminal. Under such circumstances the reliability of printing is even more important because customers will use that printing to distinguish between checks that have been successfully deposited and those that have not. The lack of reliability of conventional printing techniques is hindering this progress.

### SUMMARY OF THE INVENTION

It is an aim of the present invention to at least partly mitigate the above-mentioned problems.

It is an aim of certain embodiments of the present invention to provide a method and apparatus for determining when a printing process has been correctly carried out.

It is an aim of certain embodiments of the present invention to provide a relatively low cost, simple to use process for determining printer error which can be carried out automatically by a terminal and which can be reported as part of a normal device error process.

According to a first aspect of the present invention there is provided a method of determining a state of operation of a print head in a Self-Service Terminal (SST), comprising the steps of:
determining at least one input optical value for an item of media as it is transported to a print head prior to a print operation;
determining at least one output optical value for the item of media as it is transported from the print head subsequent to a print operation;
comparing the input and output optical values; and
responsive to said comparison, determining a state of operation of the print head.

Aptly, the step of determining at least one input optical value includes determining at least one reflectance value.

Aptly, the step of determining at least one reflectance value includes determining at least one reflectance value at a specific point on the item of media; and the step of determining at least one output optical value for the item of media as it is transported from the print head subsequent to a print operation includes determining at least one reflectance value at the same specific point on the item of media.

Aptly, the method further comprises the steps of calibrating an input sensor output and output sensor output by detecting radiation reflected at a common non-printed region of the item of media.

Aptly, the step of determining at least one input optical value includes determining a plurality of input optical values, each optical value being associated with a different predetermined location on the item of media; the step of determining at least one output optical value includes determining a plurality of output optical values, each optical value being associated with the same predetermined location on the item of media as a corresponding input optical value; and comparing the input and output optical values includes comparing each input optical value with the corresponding output optical value relating to the same predetermined location on the item of media.

Aptly, the step of comparing the input and output optical values comprises:
for each pre-determined location, determining an actual difference between the input reflectance value and output reflectance value; and
comparing each actual difference with a corresponding expected difference.

Aptly, the method further comprises the steps of determining that a print head is in a fully functioning state if each actual difference substantially matches the corresponding expected difference.

Aptly, the method further comprises the steps of determining if the print head is in a partially functioning state or non-functioning state responsive to a variation between the actual difference and the expected difference.

Aptly, the method further comprises the steps of, over a pre-determined period of time, determining a running difference of the variation between an expected difference and the actual difference.

Aptly, the method further comprises the step of comparing a running difference value with at least one threshold value and determining said state of operation responsive thereto.

Aptly, the method further comprises the steps of, for each item of media, printing a pre-determined test pattern on the item in addition to further print data;
detecting an output test pattern reflectance value for the region of the item of media where the test pattern is printed; and
determining print density responsive to the detected test pattern reflectance value.

According to a second aspect of the present invention there is provided apparatus for determining a state of operation of a print head of a Self-Service Terminal (SST), comprising:
a print head that selectively prints on items of media transported one-by-one along a transport pathway proximate to the print head;
an input optical sensor pair that determines an input optical value of an item of media;
an output optical sensor pair that determines an output optical value of an item of media; and
a processor that compares the input and output optical values and determines a state of operation of the print head responsive thereto.

Aptly, the apparatus further comprises a data store that stores expected difference values for a respective item of media.

Aptly, the print head is arranged to print a test block having at least one pre-determined characteristic on each item of media with further print data.

According to a third aspect of the present invention there is provided a product which comprises a computer programme comprising programme instructions for:
determining at least one input reflectance value for an item of media as it is transported to a printer element;
determining at least one output reflectance value for the item of media as it is transported from the printer element;
comparing the input and output reflectance values; and
responsive to said comparison, determining a state of operation of the printer element.

Certain embodiments of the present invention provide the advantage that a failure of a printing function in an SST can be detected immediately after the printing step.

Certain embodiments of the present invention can detect failure of a printing process in an envelope deposit module of an ATM.

Certain embodiments of the present invention prevent excessive processing costs related to manually tracing deposits back to a depositing customer.

Certain embodiments of the present invention provide the advantage that low cost reflective sensor pairs can be utilized before and after a print head in line with a track direction. Before and after samples are taken and using item velocity data an optical (such as reflective or transmissive) difference value is calculated for various points along an item. These values are compared by the device with a difference that is expected based on the printing carried out.

Certain embodiments of the present invention allow for sensor calibration to take place to optimize performance.

Certain embodiments of the present invention provide the advantage that performance can be optimized by printing test prints of a pre-determined pattern on documents.

Certain embodiments of the present invention provide the advantage that thresholding can be continually monitored to report on trends rather than one off measurements. This helps avoid incorrect fault reporting due to, for example, printing on check faces with backgrounds or dirty checks.

### BRIEF DESCRIPTION OF DRAWINGS

Embodiments of the present invention will now be described hereinafter, by way of example only, with reference to the accompanying drawings in which:

FIG. 1 illustrates a schematic diagram of a Self-Service Terminal (SST) in the form of an Automated Teller Machine (ATM);

FIG. 2 illustrates a schematic diagram of a media dispenser/depository located within the ATM of FIG. 1; and

FIG. 3 illustrates operation of a printer element in the media dispenser/depository of FIG. 2, according to an embodiment of the present invention.

### DESCRIPTION OF EMBODIMENTS

In the drawings like reference numerals refer to like parts.

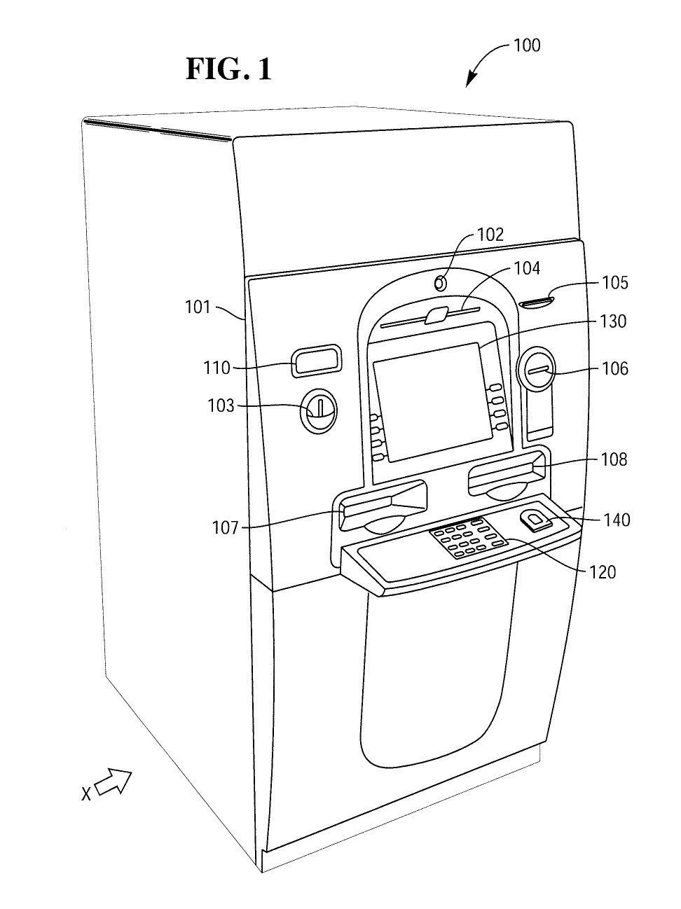

FIG. 1 illustrates a self-service check depositing terminal in the form of an image-based check depositing Automated Teller Machine (ATM) 100. It will be appreciated that certain embodiments of the present invention are applicable to a wide variety of terminals in which items of media such as checks and/or currency notes and/or giros and/or lottery tickets and/or envelopes and/or other such flexible sheet-like items of media are to be transported and invalidated subsequent to a value of the item being exhausted/utilized or when an item is identified as being a forgery. The type of terminal will of course be appropriate for the type of items of media being transported.

As illustrated in FIG. 1, the ATM 100 includes a fascia 101 coupled to a chassis (not shown). The fascia 101 defines an aperture 102 through which a camera (not shown) images a customer of the ATM 100. The fascia 101 also defines a number of slots for receiving and dispensing media items and a tray 103 into which coins can be dispensed. The slots include a statement output slot 104, a receipt slot 105, a card reader slot 106, a cash dispense slot 107, a cash and check deposit slot 108 and a branding badge 110. The slots and tray are arranged such that the slots and tray align with corresponding ATM modules mounted within the chassis of the ATM.

The fascia 101 provides a user interface for allowing an ATM customer to execute a transaction. The fascia 101 includes an encrypting keyboard 120 for allowing an ATM customer to enter transaction details. A display 130 is provided for presenting screens to an ATM customer. A fingerprint reader 140 is provided for reading a fingerprint of an ATM customer to identify the ATM customer.

Within the chassis of the ATM it will be understood that items of media must be transported from time to time from one location to another. The pathway taken by any particular item of media is dependent upon an operation being carried out at the ATM and may also be dependent upon other factors such as whether a user of the ATM is authorized and/or whether an item of media being transported satisfies certain pre-determined criteria.

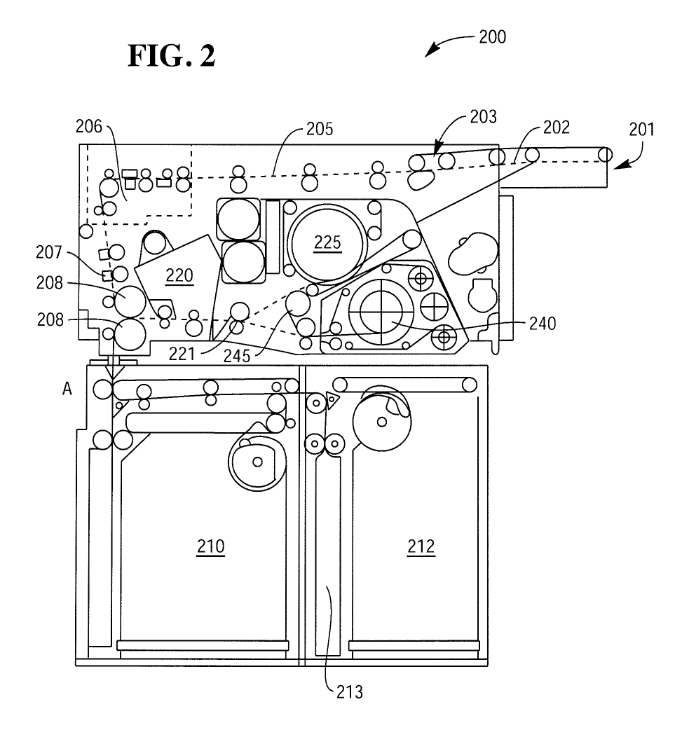

FIG. 2 illustrates possible transport pathways and processing modules within the ATM. In more detail, FIG. 2 illustrates internal zones within the ATM which can be utilized to process deposited checks. A cash and check processing module 200 has an access mouth 201 through which incoming checks and/or currency notes are deposited or outgoing checks and/or currency notes are dispensed. This mouth 201 is aligned with an infeed aperture in the ATM which thus provides a cash/check input/output slot 108. A bunch of one or more items is input or output. Aptly, a bunch of up to 100 items can be received/dispensed. Aptly, a bunch of up to 500 items can be received/dispensed. Incoming deposited checks follow a first transport path 202 away from the mouth 201 in a substantially horizontal direction from right to left shown in FIG. 2. They then pass through a feeder/separator 203 and then pass one-by-one along another pathway portion 205 which is also substantially horizontal and right to left. The items are then de-skewed and then read by an imaging and note validation module 206 which includes imaging cameras. Items are then directed substantially vertically downwards past an MICR reader 207 to a point between two nip rollers 208.

The nip rollers co-operate and are rotated in opposite directions with respect to each other to either draw deposited checks inwards (and urge those checks towards the right hand side in FIG. 2), or during another mode of operation, the rollers can be rotated in an opposite fashion to direct processed checks downwards in the direction shown by arrow A in FIG. 2 into a check bin 210 and/or a check retract bin and/or cash bin 212 or cash retract bin 213 of the capture bin module. Incoming checks which are moved by the nip rollers 208 towards the right, enter an endorser 220 which is a printer that will be described hereinafter in more detail. A first diverter mechanism 221 can either divert the incoming checks and/or currency notes upwards (in FIG. 2) into a re-buncher unit 225, or to the right hand side shown in FIG. 2 into an escrow 240.

Items of media from the escrow 240 can selectively be removed from a storage drum and re-processed after temporary storage. This results in items of media moving from the escrow 240 towards the left hand side of FIG. 2 where they may be redirected by a further diverter mechanism 245 and may again enter the first diverter mechanism 220. The further diverter mechanism 245 can be utilized to allow the transported checks to move substantially unimpeded towards the left hand side and the first diverter mechanism 221 and hence the nip rollers 208 or upwards towards the recycler 225. Currency notes from the escrow can be directed to the re-buncher 225 or downwards into the cash bin 230.

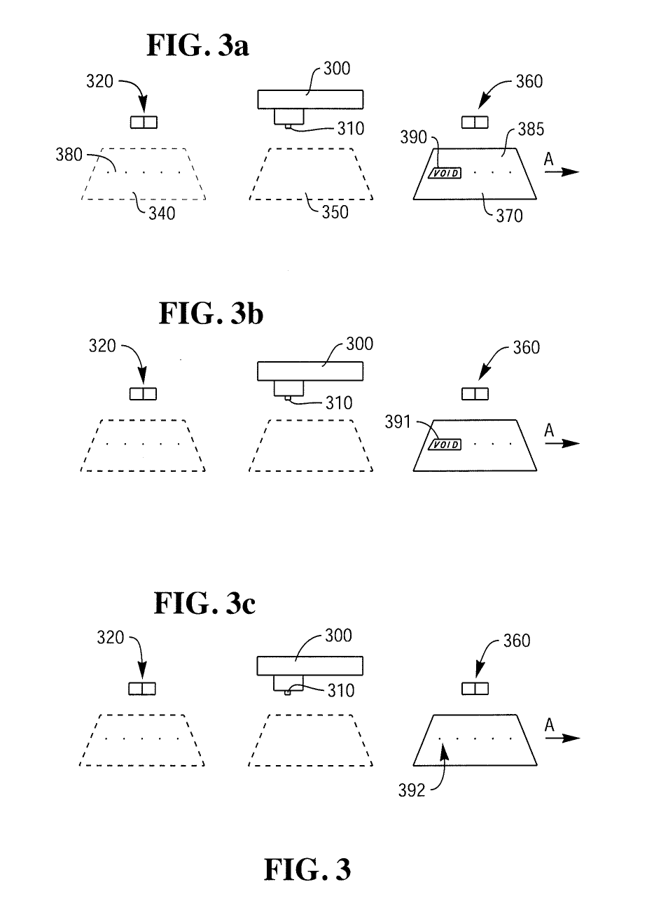

FIG. 3 illustrates apparatus that can be utilized to determine a state of operation of a check endorsement printer of the SST according to an embodiment of the present invention. As illustrated in FIG. 3a, a printer station 300 includes a print head 310. The print head is utilized to print a pre-determined or programmable pattern on an item of media such as a check or envelope in which a currency note and/or check is deposited. The printed pattern is, for example, the word “VOID”. The printing is utilized to indicate that the item of media has been processed in the terminal. The printer station 300 and print head 310 are located at a fixed position with respect to a transport pathway (illustrated by arrow A) in the ATM 100.

A first reflectance sensor array 320 is arranged upstream of the print station 300. That is to say, is located so as to measure a reflectance value of an item at a location 340 prior to the item reaching a location 350 where the print head 310 is located. A second reflectance sensor array 360 is arranged downstream of the print station 300. That is to say, is located proximate to a location 370 which an item of media will reach as it is transported along the transport pathway after the print station 300. Each reflectance sensor array 320, 360 is a sensor module that includes an infrared LED/phototransistor pair which thus illuminates an item of media proximate to the sensor array and detects illumination reflected from the item of media and surrounding area. It will be appreciated that other types of reflectance sensor may be utilized according to certain other embodiments of the present invention.

Each sensor array 320, 360 is arranged to provide a reflectance value at one of five pre-determined locations on an item of media. These test or monitoring positions are spaced apart in a line 380 along the longitudinal length of an item of media.

In use, an item of media 385 is transported along the transport pathway to the first location 340 proximate to where the first sensor array 320 is located. It will be understood that the item may be halted at that position or the item may be continually transported with reflectance sensing occurring on a moving item. When the item, which has yet to be printed on, reaches this first location 340, the reflectance value at the five pre-determined locations along the line 380 is determined. The item then continues on to the middle location 350 where the item is presented to the print head. Printing then occurs on the item. The item may be halted at the middle location 350 or printing may optionally be carried out as the item continues to be transported. FIG. 3a illustrates the item 385 at the third location 370 and indicates how a printed mark 390 has been printed on the item by the print head 310 to indicate that that item has been processed. The particular mark 390 illustrated in FIG. 3a is illustrated as the word VOID set out within a rectangular block which bridges across two of the pre-determined test points in the line 380 of test points. It will be appreciated that other patterns, shapes and sizes of print could of course be printed on the item of media by the print head.

The steps shown in FIG. 3a illustrates a situation in which the print head is fully operational. That is to say, the printing occurs in a clear and fully toned manner. The pattern 390 which the print head 310 is to print on an item of media is pre-determined. Likewise, the location on an item of media where the pattern 390 is printed is known. Therefore, for each of the five points an expected difference in reflectance is stored in a data store of the terminal 100. These pre-stored values are generated by a prior test phase and are either factory set or may be determined locally using test target media. As illustrated in FIG. 3a, with the item of media at the first location 340 the pale surface of an item would be expected to be highly reflective at all five points along the line of pre-determined points. By contrast, the dark printing of the pattern 390 printed over the first two points means that reflectance values measured there will be significantly lower than at the three remaining points. As a result, when the printer is fully operational, there will be a considerable expected difference between reflectance at the first and second points of the five points whereas there will be little or no expected difference in reflectance at the three points where printing is not expected to take place.

Table 1 illustrates an expected difference and actual measured difference at the five points shown in FIG. 3a and also indicates how a variation between the actual detected difference and the expected difference is determined.

TABLE 1

| | | Expected | |
|---|---|---|---|
| Point | Actual Difference | Difference | Variation |
| 1 | 5 | 5 | 0 |
| 2 | 5 | 5 | 0 |
| 3 | 0 | 0 | 0 |
| 4 | 0 | 0 | 0 |
| 5 | 0 | 0 | 0 |

FIG. 3b illustrates the print station 300 and sensor arrays 320, 360 at a different moment in time in which the print head 310 is beginning to fail. Under these circumstances, the pattern 391 printed on an item 385 at the print station 300 and as detected by the downstream sensor array 360 is paler. This may occur, for example, because printer ink is running out in the print station 300.

Table 2 illustrates the actual difference in reflection values at the five detection points and how this varies with respect to an expected difference at each of those points. This time because the printed pattern 391 is less dark and thus less absorbent at the first two test points, the difference in reflectance between those two test points before and after printing is less marked. When this actual difference is compared with an expected difference at those two test points, a significant variation is identified.

TABLE 2

| Point | Actual difference | Expected difference | Variation |
|---|---|---|---|
| 1 | 2 | 5 | 3 |
| 2 | 3 | 5 | 2 |
| 3 | 0 | 0 | 0 |
| 4 | 0 | 0 | 0 |
| 5 | 0 | 0 | 0 |

FIG. 3c illustrates printing in circumstances where printing fails. This may occur, for example, because of printer ink running out completely in the printer station 300. As illustrated in FIG. 3c, the print pattern 392 printed by the print head 310 is non-existent. Thus, the reflectance of the incoming item of media prior to the print station 300 will exactly match the reflectance values at the five test points for an item of media downstream of the printer station. Table 3 illustrates the actual difference values and expected difference values at the five test points.

TABLE 3

| Point | Actual difference | Expected difference | Variation |
|---|---|---|---|
| 1 | 0 | 5 | 5 |
| 2 | 0 | 5 | 5 |
| 3 | 0 | 0 | 0 |
| 4 | 0 | 0 | 0 |
| 5 | 0 | 0 | 0 |

Table 3 also illustrates how the variation between actual difference and expected difference at the five test points is increased. In the instance shown in Table 3 the variation between the actual difference and expected difference at the first two test points is 5. A threshold value which may be appropriately set and, by way of example, is 4 in the example described, is thus exceeded in the state shown in FIG. 3c. By comparing a variation value at each test point with a threshold value an alert flag can be set to indicate print failing. Optionally, transportation of the item can be halted as can further processing with an item which has not been correctly printed on being returned to a user or stored in the terminal for authorized user action.

It will be appreciated that by constantly monitoring variation values trending of operation of the printer station 200 can be determined. For example, over time as printer ink is used up, a printed mark will tend to progressively become fainter. This will manifest itself as a general increase in the variation value at certain test points where printing is known to occur. Rather than trigger an authorized user to come and replace printer ink, on the occasion of a single failure, trending can be utilized to change printer ink only after a general degradation in printing has been indicated by a generally increasing variation score at test points where printing is to take place. This can be monitored over time. This helps avoid incorrect fault reporting due to perhaps printing on a single particular check face or envelope which has a dirty area or colored background.

Sensor calibration can take place on each item or on items at a pre-determined regularity (for example, every tenth item). This can be carried out by sensing reflectance values at an area of an item where printing is known not to occur. Likewise, test prints of solid block printing done intentionally on documents can optionally be carried out. Measuring reflectance values can be used to measure print density.

Certain embodiments of the present invention are thus usable in an envelope depository or check processing module. The depository includes a motorized transport with various sensors, an ink-jet based printing system and at least one depository bin. A shutter on the fascia of an ATM controls access to the depository transport. The module is controlled by microprocessor-based PCB with firmware on an EPROM. A customer application opens the fascia shutter and signals to a cardholder that the ATM is ready to accept a check or envelope. In the case of an envelope, the envelope is inserted through the fascia slot where the transport pulls it through the shutter. When the envelope has cleared the first (entry) sensor the shutter is closed. When the envelope has cleared a second sensor the envelope is printed with either a four-digit serial number or a code of up to eight characters defined by the customer application. When the envelope has cleared the exit sensor it is assumed to have fallen into a depository bin and the transport is stopped. As the bin becomes full the envelope cannot fall clear of the exit sensor and a bin full condition is reported to the system. On a third successive occurrence of the exit sensor remaining blocked the bin full condition becomes fatal and the depository is disabled.

Various modifications may be made to the above described embodiments within the scope of the present invention. For example, instead of using reflectance, a pair of sensors may be provided that measure transmission. In such embodiments, a source (such as an LED) may be located on one side of a media item, and a receiver (such as a photodiode) may be located on the opposite side of the media item. Alternatively, a mirror may be located on one side of the media item and a source and receiver may be located on the opposite side of the media item.

Aptly, a printed word or device that is printed on an item of media indicates that a value associated with the item has been exhausted. Aptly, in addition the print head is arranged to print a test pattern in addition to the processing pattern. The test pattern is aptly a square block of pre-determined tone density.

It will be appreciated that the transport pathway where the printing station is located may be at any appropriate position in the ATM; for example, in the endorser 220 of the cash and check processing module.

Optionally, the test points may of course be arranged in any convenient configuration. The sensors themselves may optionally be utilized to identify edges and/or other pre-determined features of an item of media so as to ensure that the points where reflectance values are measured are themselves accurately identified. Other techniques could of course be utilized to identify the test points where reflective characteristics are measured.

Optionally, in circumstances where it may not be possible to predict where text will be printed, it may be necessary to monitor a large number of points before printing. In such circumstances, an array of sensors that stretch across an entire width of the item of media are provided. If pre-determined test points are not utilized reflectance or transmission values in general pre and post printing may be compared to determine likely or actual printer failure. Expected difference values are thus optional.

Whilst certain embodiments of the present invention have been described with respect to the monitoring and detection of reflectance values, it will of course be appreciated that in addition to, or as an alternative, transmission characteristics through an item of media could be monitored. It will be appreciated that a transmission value prior to printing will be different to a transmission value of an area of an item of media where printing has occurred.

Throughout the description and claims of this specification, the words “comprise” and “contain” and variations of them mean “including but not limited to” and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of the features and/or steps are mutually exclusive. The invention is not restricted to any details of any foregoing embodiments. The invention extends to any novel one, or novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

What is claimed is:

1. A method of determining a state of operation of a print head in a Self-Service Terminal (SST), comprising the steps of:
determining at least one input optical value for an item of media as it is transported to a print head prior to a print operation;
determining at least one output optical value for the item of media as it is transported from the print head subsequent to a print operation;
comparing the input and output optical values; and
responsive to said comparison, determining a state of operation of the print head.

2. The method as claimed in claim 1, wherein the step of determining at least one input optical value includes determining at least one reflectance value.

3. The method as claimed in claim 2, wherein the step of determining at least one reflectance value includes determining at least one reflectance value at a specific point on the item of media; and the step of determining at least one output optical value for the item of media as it is transported from the print head subsequent to a print operation includes determining at least one reflectance value at the same specific point on the item of media.

4. The method as claimed in claim 3, further comprising the steps of:
calibrating an input sensor output and output sensor output by detecting radiation reflected at a common non-printed region of the item of media.

5. The method as claimed in claim 1, wherein the step of determining at least one input optical value includes determining a plurality of input optical values, each optical value being associated with a different predetermined location on the item of media; the step of determining at least one output optical value includes determining a plurality of output optical values, each optical value being associated with the same predetermined location on the item of media as a corresponding input optical value; and comparing the input and output optical values includes comparing each input optical value with the corresponding output optical value relating to the same predetermined location on the item of media.

6. The method as claimed in claim 5, wherein said step of comparing the input and output optical values comprises:
for each pre-determined location, determining an actual difference between the input reflectance value and output reflectance value; and
comparing each actual difference with a corresponding expected difference.

7. The method as claimed in claim 6, further comprising the steps of:
determining that a print head is in a fully functioning state if each actual difference substantially matches the corresponding expected difference.

8. The method as claimed in claim 6, further comprising the steps of:
determining if the print head is in a partially functioning state or non-functioning state responsive to a variation between the actual difference and the expected difference.

9. The method as claimed in claim 6, further comprising the steps of:
over a pre-determined period of time, determining a running difference of the variation between an expected difference and the actual difference.

10. The method as claimed in claim 9, further comprising the steps of:
comparing a running difference value with at least one threshold value and determining said state of operation responsive thereto.

11. The method as claimed in claim 1, further comprising the steps of:
for each item of media, printing a pre-determined test pattern on the item in addition to further print data;
detecting an output test pattern reflectance value for the region of the item of media where the test pattern is printed; and
determining print density responsive to the detected test pattern reflectance value.

12. Apparatus for determining a state of operation of a print head, comprising:
a print head that selectively prints on items of media transported one-by-one along a transport pathway proximate to the print head;
an input optical sensor pair that determines an input optical value of an item of media;
an output optical sensor pair that determines an output optical value of an item of media; and
a processor that compares the input and output optical values and determines a state of operation of the print head responsive thereto.

13. The apparatus as claimed in claim 12, further comprising:
a data store that stores expected difference values for a respective item of media.

14. The apparatus as claimed in claim 12, wherein:
the print head is arranged to print a test block having at least one pre-determined characteristic on each item of media with further print data.

15. A product which comprises a computer programme comprising programme instructions for:
determining at least one input optical value for an item of media as it is transported to a printer element;
determining at least one output optical value for the item of media as it is transported from the printer element;
comparing the input and output optical values; and
responsive to said comparison, determining a state of operation of the printer element.
